(19) United States
(12) Patent Application Publication
(10) Pub. No.: US 2023/0145869 A1
(43) Pub. Date: May 11, 2023

(54) Surface Wiping Tool for a Robot

(71) Applicant: X Development LLC, Mountain View, CA (US)

(72) Inventor: Courtney Kobata, Daly City, CA (US)

(21) Appl. No.: 18/054,317

(22) Filed: Nov. 10, 2022

Related U.S. Application Data
(60) Provisional application No. 63/263,837, filed on Nov. 10, 2021.

(51) Int. Cl. B08B 1/00; B25J 11/00; B08B 3/04; B08B 13/00

(52) U.S. Cl. CPC B08B 1/006; B25J 11/0085; B08B 3/04; B08B 1/008; B08B 13/00

(57) ABSTRACT

A robotic device includes one or more robotic fingers and an attachable wiping tool. The attachable wiping tool includes a wiping component, a container configured to dispense a fluid, and an attachment component coupled to the robotic device. The attachment component is configured to align the one or more robotic fingers with the container such that the one or more robotic fingers, when actuated, engage the container to cause the container to dispense the fluid to the wiping component.

### CROSS-REFERENCE TO RELATED APPLICATIONS

This application claims priority to U.S. Provisional Patent Application No. 63/263,837, filed Nov. 10, 2021, the disclosure of which is incorporated by reference herein in its entirety.

### BACKGROUND

As technology advances, various types of robotic devices are being created for performing a variety of functions that may assist users. Robotic devices may be used for applications involving material handling, transportation, welding, assembly, and dispensing, among others. Over time, the manner in which these robotic systems operate is becoming more intelligent, efficient, and intuitive. As robotic systems become increasingly prevalent in numerous aspects of modern life, it is desirable for robotic systems to be efficient. Therefore, a demand for efficient robotic systems has helped open up a field of innovation in actuators, movement, sensing techniques, as well as component design and assembly.

### SUMMARY

Example embodiments involve a surface wiping tool for a robot. The wiping tool may include an attachment component that attaches to a portion of the robot (e.g., a robotic wrist) in an arrangement that positions a container of fluid between fingers of the robot. When the robot actuates the fingers, the container may then dispense the fluid to a wiping component (e.g., a sponge) of the tool. With the fluid applied, the robot may control the wiping component to clean a surface such as a table or a whiteboard.

In an embodiment, a robotic device includes one or more robotic fingers and an attachable wiping tool. The attachable wiping tool includes a wiping component, a container configured to dispense a fluid, and an attachment component coupled to the robotic device. The attachment component is configured to align the one or more robotic fingers with the container such that the one or more robotic fingers, when actuated, engage the container to cause the container to dispense the fluid to the wiping component.

In another embodiment, an attachable wiping tool for a robotic device includes a wiping component, a container configured to dispense a fluid, and an attachment component configured to couple to the robotic device. The attachment component is configured to align one or more robotic fingers of the robotic device with the container such that the one or more robotic fingers, when actuated, engage the container to cause the container to dispense the fluid to the wiping component.

In a further embodiment, a method includes causing one or more robotic fingers of a robotic device to engage a container of an attachable wiping tool which is attached to the robotic device, wherein the attachable wiping tool is attached to the robotic device by an attachment component which aligns the one or more robotic fingers with the container in order to enable the one or more robotic fingers to engage the container to cause the container to dispense a fluid to a wiping component of the attachable wiping tool. The method also includes causing the wiping component of the attachable wiping tool to wipe a surface with the fluid dispensed from the container.

In a further embodiment, a system is provided that includes means for causing one or more robotic fingers of a robotic device to engage a container of an attachable wiping tool which is attached to the robotic device, wherein the attachable wiping tool is attached to the robotic device by an attachment component which aligns the one or more robotic fingers with the container in order to enable the one or more robotic fingers to engage the container to cause the container to dispense a fluid to a wiping component of the attachable wiping tool. The system also includes means for causing the wiping component of the attachable wiping tool to wipe a surface with the fluid dispensed from the container.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates a configuration of a robotic system, in accordance with example embodiments.

FIG. 2 illustrates a mobile robot, in accordance with example embodiments.

FIG. 3 illustrates an exploded view of a mobile robot, in accordance with example embodiments.

FIG. 4 illustrates a robotic arm, in accordance with example embodiments.

FIGS. 5A-5D illustrate a surface wiping tool, in accordance with example embodiments.

FIG. 6 illustrates robotic fingers associated with a surface wiping tool, in accordance with example embodiments.

FIG. 7 illustrates a tray for a robot, in accordance with example embodiments.

FIG. 8 is a block diagram of a method, in accordance with example embodiments.

FIG. 9 illustrates another surface wiping tool, in accordance with example embodiments.

FIG. 10 illustrates a surface wiping tool with removable sponge and detachable cloth, in accordance with example embodiments.

FIG. 11 illustrates a captive fastener for a surface wiping tool, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

A robotic device may be configured to perform various tasks in an environment, such as a residential environment, an office space, or a factory. In some examples, the tasks may include cleaning one or more surfaces in the environment, such as a table top or a white board. In order to facilitate robotic cleaning of such surfaces, an integrated liquid dispensing tool (also referred to as an attachable wiping tool) is disclosed herein. The tool may facilitate precise surface cleaning while leveraging existing robotic end-of-arm instructure.

More specifically, a robotic device may be equipped with one or more robotic fingers as part of an end-of-arm gripper. The gripper and finger(s) may be leveraged to engage a container of fluid (e.g., a cleaning fluid or water) to cause the container to dispense the fluid for cleaning a surface. The wiping tool may include an attachment component which fixedly attaches the tool to the robot. For instance, a mounting bracket may be coupled to a wrist of the robot to attach the tool to the robot. When the tool is attached by the attachment component, the fluid container may be positioned to enable contact by one or more fingers of the robot's gripper. For instance, the container may be positioned between opposable fingers of an end-of-arm gripper so that when the fingers are actuated, they contact the container and cause the container to dispense the fluid.

When the fluid is dispensed by the container, the fluid may be provided to a wiping component, such as a sponge, to wipe a surface. In examples where a sponge is used, the sponge may be replaceable (e.g., removable from the wiping component via a sliding motion). In some examples, the fluid may be provided to the back of the wiping component at one or more points in order to saturate the wiping component. In other examples, the wiping component may include a cut-out portion to allow the fluid to be applied through the wiping component directly to the surface. In some examples, a tubing attached to the container may connect with at least one hose which transports the fluid to the wiping component. Such examples may facilitate removing and replacing of an empty container.

Further examples and variations of an attachable wiping tool for a robot are discussed in reference to the Figures of this application. In addition, methods for improving robotic operation in the context of using the attachable wiping tool and/or performing cleaning tasks or other types of robot tasks are described as well.

### II. Example Robotic Systems

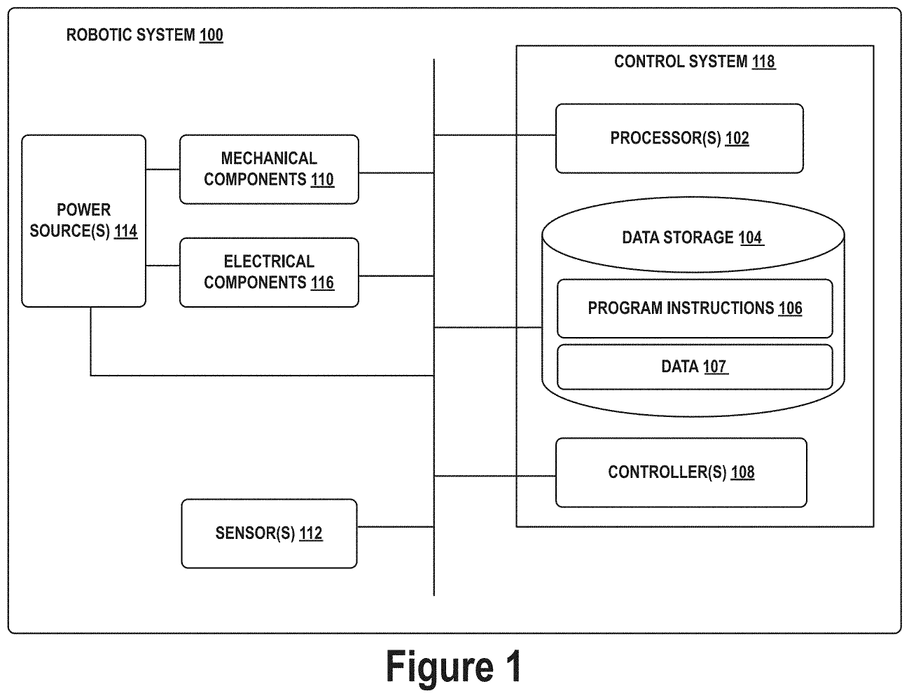

FIG. 1 illustrates an example configuration of a robotic system that may be used in connection with the implementations described herein. Robotic system 100 may be configured to operate autonomously, semi-autonomously, or using directions provided by user(s). Robotic system 100 may be implemented in various forms, such as a robotic arm, industrial robot, or some other arrangement. Some example implementations involve a robotic system 100 engineered to be low cost at scale and designed to support a variety of tasks. Robotic system 100 may be designed to be capable of operating around people. Robotic system 100 may also be optimized for machine learning. Throughout this description, robotic system 100 may also be referred to as a robot, robotic device, or mobile robot, among other designations.

As shown in FIG. 1, robotic system 100 may include processor(s) 102, data storage 104, and controller(s) 108, which together may be part of control system 118. Robotic system 100 may also include sensor(s) 112, power source(s) 114, mechanical components 110, and electrical components 116. Nonetheless, robotic system 100 is shown for illustrative purposes, and may include more or fewer components. The various components of robotic system 100 may be connected in any manner, including wired or wireless connections. Further, in some examples, components of robotic system 100 may be distributed among multiple physical entities rather than a single physical entity. Other example illustrations of robotic system 100 may exist as well.

Processor(s) 102 may operate as one or more general-purpose hardware processors or special purpose hardware processors (e.g., digital signal processors, application specific integrated circuits, etc.). Processor(s) 102 may be configured to execute computer-readable program instructions 106, and manipulate data 107, both of which are stored in data storage 104. Processor(s) 102 may also directly or indirectly interact with other components of robotic system 100, such as sensor(s) 112, power source(s) 114, mechanical components 110, or electrical components 116.

Data storage 104 may be one or more types of hardware memory. For example, data storage 104 may include or take the form of one or more computer-readable storage media that can be read or accessed by processor(s) 102. The one or more computer-readable storage media can include volatile or non-volatile storage components, such as optical, magnetic, organic, or another type of memory or storage, which can be integrated in whole or in part with processor(s) 102. In some implementations, data storage 104 can be a single physical device. In other implementations, data storage 104 can be implemented using two or more physical devices, which may communicate with one another via wired or wireless communication. As noted previously, data storage 104 may include the computer-readable program instructions 106 and data 107. Data 107 may be any type of data, such as configuration data, sensor data, or diagnostic data, among other possibilities.

Controller 108 may include one or more electrical circuits, units of digital logic, computer chips, or microprocessors that are configured to (perhaps among other tasks), interface between any combination of mechanical components 110, sensor(s) 112, power source(s) 114, electrical components 116, control system 118, or a user of robotic system 100. In some implementations, controller 108 may be a purpose-built embedded device for performing specific operations with one or more subsystems of the robotic system 100.

Control system 118 may monitor and physically change the operating conditions of robotic system 100. In doing so, control system 118 may serve as a link between portions of robotic system 100, such as between mechanical components 110 or electrical components 116. In some instances, control system 118 may serve as an interface between robotic system 100 and another computing device. Further, control system 118 may serve as an interface between robotic system 100 and a user. In some instances, control system 118 may include various components for communicating with robotic system 100, including a joystick, buttons, or ports, etc. The example interfaces and communications noted above may be implemented via a wired or wireless connection, or both. Control system 118 may perform other operations for robotic system 100 as well.

During operation, control system 118 may communicate with other systems of robotic system 100 via wired or wireless connections, and may further be configured to communicate with one or more users of the robot. As one possible illustration, control system 118 may receive an input (e.g., from a user or from another robot) indicating an instruction to perform a requested task, such as to pick up and move an object from one location to another location. Based on this input, control system 118 may perform operations to cause the robotic system 100 to make a sequence of movements to perform the requested task. As another illustration, a control system may receive an input indicating an instruction to move to a requested location. In response, control system 118 (perhaps with the assistance of other components or systems) may determine a direction and speed to move robotic system 100 through an environment en route to the requested location.

Operations of control system 118 may be carried out by processor(s) 102. Alternatively, these operations may be carried out by controller(s) 108, or a combination of processor(s) 102 and controller(s) 108. In some implementations, control system 118 may partially or wholly reside on a device other than robotic system 100, and therefore may at least in part control robotic system 100 remotely.

Mechanical components 110 represent hardware of robotic system 100 that may enable robotic system 100 to perform physical operations. As a few examples, robotic system 100 may include one or more physical members, such as an arm, an end effector, a head, a neck, a torso, a base, and wheels. The physical members or other parts of robotic system 100 may further include actuators arranged to move the physical members in relation to one another. Robotic system 100 may also include one or more structured bodies for housing control system 118 or other components, and may further include other types of mechanical components. The particular mechanical components 110 used in a given robot may vary based on the design of the robot, and may also be based on the operations or tasks the robot may be configured to perform.

In some examples, mechanical components 110 may include one or more removable components. Robotic system 100 may be configured to add or remove such removable components, which may involve assistance from a user or another robot. For example, robotic system 100 may be configured with removable end effectors or digits that can be replaced or changed as needed or desired. In some implementations, robotic system 100 may include one or more removable or replaceable battery units, control systems, power systems, bumpers, or sensors. Other types of removable components may be included within some implementations.

Robotic system 100 may include sensor(s) 112 arranged to sense aspects of robotic system 100. Sensor(s) 112 may include one or more force sensors, torque sensors, velocity sensors, acceleration sensors, position sensors, proximity sensors, motion sensors, location sensors, load sensors, temperature sensors, touch sensors, depth sensors, ultrasonic range sensors, infrared sensors, object sensors, or cameras, among other possibilities. Within some examples, robotic system 100 may be configured to receive sensor data from sensors that are physically separated from the robot (e.g., sensors that are positioned on other robots or located within the environment in which the robot is operating).

Sensor(s) 112 may provide sensor data to processor(s) 102 (perhaps by way of data 107) to allow for interaction of robotic system 100 with its environment, as well as monitoring of the operation of robotic system 100. The sensor data may be used in evaluation of various factors for activation, movement, and deactivation of mechanical components 110 and electrical components 116 by control system 118. For example, sensor(s) 112 may capture data corresponding to the terrain of the environment or location of nearby objects, which may assist with environment recognition and navigation.

In some examples, sensor(s) 112 may include RADAR (e.g., for long-range object detection, distance determination, or speed determination), LIDAR (e.g., for short-range object detection, distance determination, or speed determination), SONAR (e.g., for underwater object detection, distance determination, or speed determination), VICON® (e.g., for motion capture), one or more cameras (e.g., stereoscopic cameras for 3D vision), a global positioning system (GPS) transceiver, or other sensors for capturing information of the environment in which robotic system 100 is operating. Sensor(s) 112 may monitor the environment in real time, and detect obstacles, elements of the terrain, weather conditions, temperature, or other aspects of the environment. In another example, sensor(s) 112 may capture data corresponding to one or more characteristics of a target or identified object, such as a size, shape, profile, structure, or orientation of the object.

Further, robotic system 100 may include sensor(s) 112 configured to receive information indicative of the state of robotic system 100, including sensor(s) 112 that may monitor the state of the various components of robotic system 100. Sensor(s) 112 may measure activity of systems of robotic system 100 and receive information based on the operation of the various features of robotic system 100, such as the operation of an extendable arm, an end effector, or other mechanical or electrical features of robotic system 100. The data provided by sensor(s) 112 may enable control system 118 to determine errors in operation as well as monitor overall operation of components of robotic system 100.

As an example, robotic system 100 may use force/torque sensors to measure load on various components of robotic system 100. In some implementations, robotic system 100 may include one or more force/torque sensors on an arm or end effector to measure the load on the actuators that move one or more members of the arm or end effector. In some examples, the robotic system 100 may include a force/torque sensor at or near the wrist or end effector, but not at or near other joints of a robotic arm. In further examples, robotic system 100 may use one or more position sensors to sense the position of the actuators of the robotic system. For instance, such position sensors may sense states of extension, retraction, positioning, or rotation of the actuators on an arm or end effector.

As another example, sensor(s) 112 may include one or more velocity or acceleration sensors. For instance, sensor(s) 112 may include an inertial measurement unit (IMU). The IMU may sense velocity and acceleration in the world frame, with respect to the gravity vector. The velocity and acceleration sensed by the IMU may then be translated to that of robotic system 100 based on the location of the IMU in robotic system 100 and the kinematics of robotic system 100.

Robotic system 100 may include other types of sensors not explicitly discussed herein. Additionally or alternatively, the robotic system may use particular sensors for purposes not enumerated herein.

Robotic system 100 may also include one or more power source(s) 114 configured to supply power to various components of robotic system 100. Among other possible power systems, robotic system 100 may include a hydraulic system, electrical system, batteries, or other types of power systems. As an example illustration, robotic system 100 may include one or more batteries configured to provide charge to components of robotic system 100. Some of mechanical components 110 or electrical components 116 may each connect to a different power source, may be powered by the same power source, or be powered by multiple power sources.

Any type of power source may be used to power robotic system 100, such as electrical power or a gasoline engine. Additionally or alternatively, robotic system 100 may include a hydraulic system configured to provide power to mechanical components 110 using fluid power. Components of robotic system 100 may operate based on hydraulic fluid being transmitted throughout the hydraulic system to various hydraulic motors and hydraulic cylinders, for example. The hydraulic system may transfer hydraulic power by way of pressurized hydraulic fluid through tubes, flexible hoses, or other links between components of robotic system 100. Power source(s) 114 may charge using various types of charging, such as wired connections to an outside power source, wireless charging, combustion, or other examples.

Electrical components 116 may include various mechanisms capable of processing, transferring, or providing electrical charge or electric signals. Among possible examples, electrical components 116 may include electrical wires, circuitry, or wireless communication transmitters and receivers to enable operations of robotic system 100. Electrical components 116 may interwork with mechanical components 110 to enable robotic system 100 to perform various operations. Electrical components 116 may be configured to provide power from power source(s) 114 to the various mechanical components 110, for example. Further, robotic system 100 may include electric motors. Other examples of electrical components 116 may exist as well.

Robotic system 100 may include a body, which may connect to or house appendages and components of the robotic system. As such, the structure of the body may vary within examples and may further depend on particular operations that a given robot may have been designed to perform. For example, a robot developed to carry heavy loads may have a wide body that enables placement of the load. Similarly, a robot designed to operate in tight spaces may have a relatively tall, narrow body. Further, the body or the other components may be developed using various types of materials, such as metals or plastics. Within other examples, a robot may have a body with a different structure or made of various types of materials.

The body or the other components may include or carry sensor(s) 112. These sensors may be positioned in various locations on the robotic system 100, such as on a body, a head, a neck, a base, a torso, an arm, or an end effector, among other examples.

Robotic system 100 may be configured to carry a load, such as a type of cargo that is to be transported. In some examples, the load may be placed by the robotic system 100 into a bin or other container attached to the robotic system 100. The load may also represent external batteries or other types of power sources (e.g., solar panels) that the robotic system 100 may utilize. Carrying the load represents one example use for which the robotic system 100 may be configured, but the robotic system 100 may be configured to perform other operations as well.

As noted above, robotic system 100 may include various types of appendages, wheels, end effectors, gripping devices and so on. In some examples, robotic system 100 may include a mobile base with wheels, treads, or some other form of locomotion. Additionally, robotic system 100 may include a robotic arm or some other form of robotic manipulator. In the case of a mobile base, the base may be considered as one of mechanical components 110 and may include wheels, powered by one or more of actuators, which allow for mobility of a robotic arm in addition to the rest of the body.

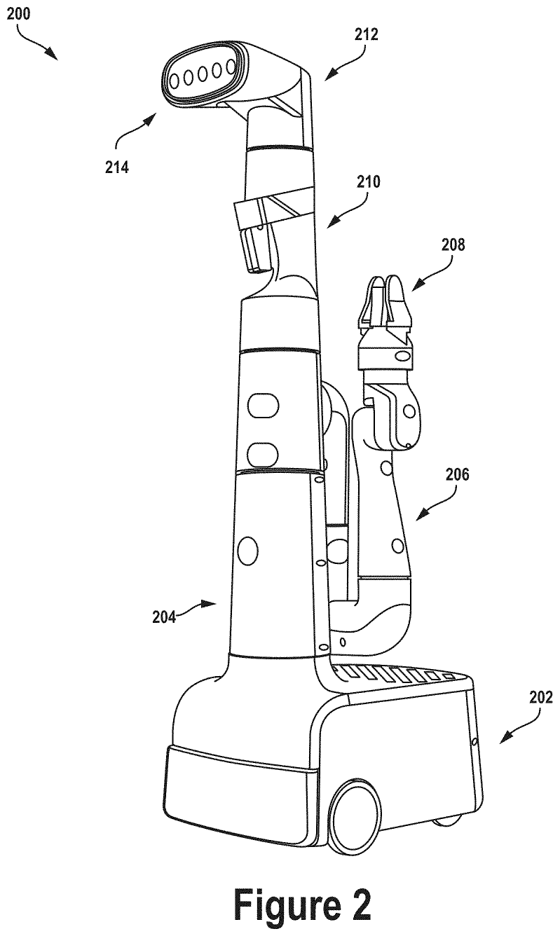

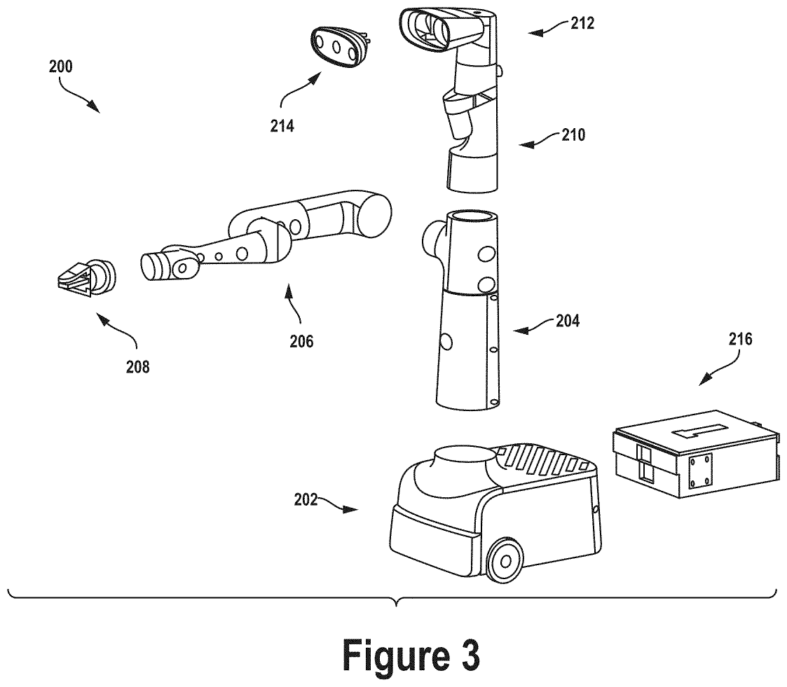

FIG. 2 illustrates a mobile robot, in accordance with example embodiments. FIG. 3 illustrates an exploded view of the mobile robot, in accordance with example embodiments. More specifically, a robot 200 may include a mobile base 202, a midsection 204, an arm 206, an end-of-arm system (EOAS) 208, a mast 210, a perception housing 212, and a perception suite 214. The robot 200 may also include a compute box 216 stored within mobile base 202.

The mobile base 202 includes two drive wheels positioned at a front end of the robot 200 in order to provide locomotion to robot 200. The mobile base 202 also includes additional casters (not shown) to facilitate motion of the mobile base 202 over a ground surface. The mobile base 202 may have a modular architecture that allows compute box 216 to be easily removed. Compute box 216 may serve as a removable control system for robot 200 (rather than a mechanically integrated control system). After removing external shells, the compute box 216 can be easily removed and/or replaced. The mobile base 202 may also be designed to allow for additional modularity. For example, the mobile base 202 may also be designed so that a power system, a battery, and/or external bumpers can all be easily removed and/or replaced.

The midsection 204 may be attached to the mobile base 202 at a front end of the mobile base 202. The midsection 204 includes a mounting column which is fixed to the mobile base 202. The midsection 204 additionally includes a rotational joint for arm 206. More specifically, the midsection 204 includes the first two degrees of freedom for arm 206 (a shoulder yaw J0 joint and a shoulder pitch J1 joint). The mounting column and the shoulder yaw J0 joint may form a portion of a stacked tower at the front of mobile base 202. The mounting column and the shoulder yaw J0 joint may be coaxial. The length of the mounting column of midsection 204 may be chosen to provide the arm 206 with sufficient height to perform manipulation tasks at commonly encountered height levels (e.g., coffee table top and counter top levels). The length of the mounting column of midsection 204 may also allow the shoulder pitch J1 joint to rotate the arm 206 over the mobile base 202 without contacting the mobile base 202.

The arm 206 may be a 7DOF robotic arm when connected to the midsection 204. As noted, the first two DOFs of the arm 206 may be included in the midsection 204. The remaining five DOFs may be included in a standalone section of the arm 206 as illustrated in FIGS. 2 and 3. The arm 206 may be made up of plastic monolithic link structures. Inside the arm 206 may be housed standalone actuator modules, local motor drivers, and thru bore cabling.

The EOAS 208 may be an end effector at the end of arm 206. EOAS 208 may allow the robot 200 to manipulate objects in the environment. As shown in FIGS. 2 and 3, EOAS 208 may be a gripper, such as an underactuated pinch gripper. The gripper may include one or more contact sensors such as force/torque sensors and/or non-contact sensors such as one or more cameras to facilitate object detection and gripper control. EOAS 208 may also be a different type of gripper such as a suction gripper or a different type of tool such as a drill or a brush. EOAS 208 may also be swappable or include swappable components such as gripper digits.

The mast 210 may be a relatively long, narrow component between the shoulder yaw J0 joint for arm 206 and perception housing 212. The mast 210 may be part of the stacked tower at the front of mobile base 202. The mast 210 may be fixed relative to the mobile base 202. The mast 210 may be coaxial with the midsection 204. The length of the mast 210 may facilitate perception by perception suite 214 of objects being manipulated by EOAS 208. The mast 210 may have a length such that when the shoulder pitch J1 joint is rotated vertical up, a topmost point of a bicep of the arm 206 is approximately aligned with a top of the mast 210. The length of the mast 210 may then be sufficient to prevent a collision between the perception housing 212 and the arm 206 when the shoulder pitch J1 joint is rotated vertical up.

As shown in FIGS. 2 and 3, the mast 210 may include a 3D lidar sensor configured to collect depth information about the environment. The 3D lidar sensor may be coupled to a carved-out portion of the mast 210 and fixed at a downward angle. The lidar position may be optimized for localization, navigation, and for front cliff detection.

The perception housing 212 may include at least one sensor making up perception suite 214. The perception housing 212 may be connected to a pan/tilt control to allow for reorienting of the perception housing 212 (e.g., to view objects being manipulated by EOAS 208). The perception housing 212 may be a part of the stacked tower fixed to the mobile base 202. A rear portion of the perception housing 212 may be coaxial with the mast 210.

The perception suite 214 may include a suite of sensors configured to collect sensor data representative of the environment of the robot 200. The perception suite 214 may include an infrared(IR)-assisted stereo depth sensor. The perception suite 214 may additionally include a wide-angled red-green-blue (RGB) camera for human-robot interaction and context information. The perception suite 214 may additionally include a high resolution RGB camera for object classification. A face light ring surrounding the perception suite 214 may also be included for improved human-robot interaction and scene illumination. In some examples, the perception suite 214 may also include a projector configured to project images and/or video into the environment.

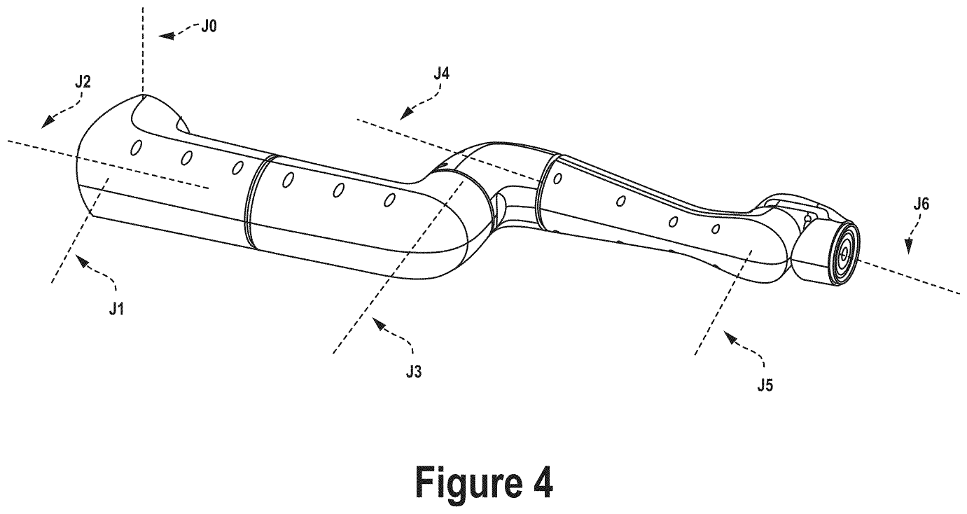

FIG. 4 illustrates a robotic arm, in accordance with example embodiments. The robotic arm includes 7 DOFs: a shoulder yaw J0 joint, a shoulder pitch J1 joint, a bicep roll J2 joint, an elbow pitch J3 joint, a forearm roll J4 joint, a wrist pitch J5 joint, and wrist roll J6 joint. Each of the joints may be coupled to one or more actuators. The actuators coupled to the joints may be operable to cause movement of links down the kinematic chain (as well as any end effector attached to the robot arm).

The shoulder yaw J0 joint allows the robot arm to rotate toward the front and toward the back of the robot. One beneficial use of this motion is to allow the robot to pick up an object in front of the robot and quickly place the object on the rear section of the robot (as well as the reverse motion). Another beneficial use of this motion is to quickly move the robot arm from a stowed configuration behind the robot to an active position in front of the robot (as well as the reverse motion).

The shoulder pitch J1 joint allows the robot to lift the robot arm (e.g., so that the bicep is up to perception suite level on the robot) and to lower the robot arm (e.g., so that the bicep is just above the mobile base). This motion is beneficial to allow the robot to efficiently perform manipulation operations (e.g., top grasps and side grasps) at different target height levels in the environment. For instance, the shoulder pitch J1 joint may be rotated to a vertical up position to allow the robot to easily manipulate objects on a table in the environment. The shoulder pitch J1 joint may be rotated to a vertical down position to allow the robot to easily manipulate objects on a ground surface in the environment.

The bicep roll J2 joint allows the robot to rotate the bicep to move the elbow and forearm relative to the bicep. This motion may be particularly beneficial for facilitating a clear view of the EOAS by the robot's perception suite. By rotating the bicep roll J2 joint, the robot may kick out the elbow and forearm to improve line of sight to an object held in a gripper of the robot.

Moving down the kinematic chain, alternating pitch and roll joints (a shoulder pitch J1 joint, a bicep roll J2 joint, an elbow pitch J3 joint, a forearm roll J4 joint, a wrist pitch J5 joint, and wrist roll J6 joint) are provided to improve the manipulability of the robotic arm. The axes of the wrist pitch J5 joint, the wrist roll J6 joint, and the forearm roll J4 joint are intersecting for reduced arm motion to reorient objects. The wrist roll J6 point is provided instead of two pitch joints in the wrist in order to improve object rotation.

In some examples, a robotic arm such as the one illustrated in FIG. 4 may be capable of operating in a teach mode. In particular, teach mode may be an operating mode of the robotic arm that allows a user to physically interact with and guide robotic arm towards carrying out and recording various movements. In a teaching mode, an external force is applied (e.g., by the user) to the robotic arm based on a teaching input that is intended to teach the robot regarding how to carry out a specific task. The robotic arm may thus obtain data regarding how to carry out the specific task based on instructions and guidance from the user. Such data may relate to a plurality of configurations of mechanical components, joint position data, velocity data, acceleration data, torque data, force data, and power data, among other possibilities.

During teach mode the user may grasp onto the EOAS or wrist in some examples or onto any part of robotic arm in other examples, and provide an external force by physically moving robotic arm. In particular, the user may guide the robotic arm towards grasping onto an object and then moving the object from a first location to a second location. As the user guides the robotic arm during teach mode, the robot may obtain and record data related to the movement such that the robotic arm may be configured to independently carry out the task at a future time during independent operation (e.g., when the robotic arm operates independently outside of teach mode). In some examples, external forces may also be applied by other entities in the physical workspace such as by other objects, machines, or robotic systems, among other possibilities.

### III. Example Surface Wiping Tools

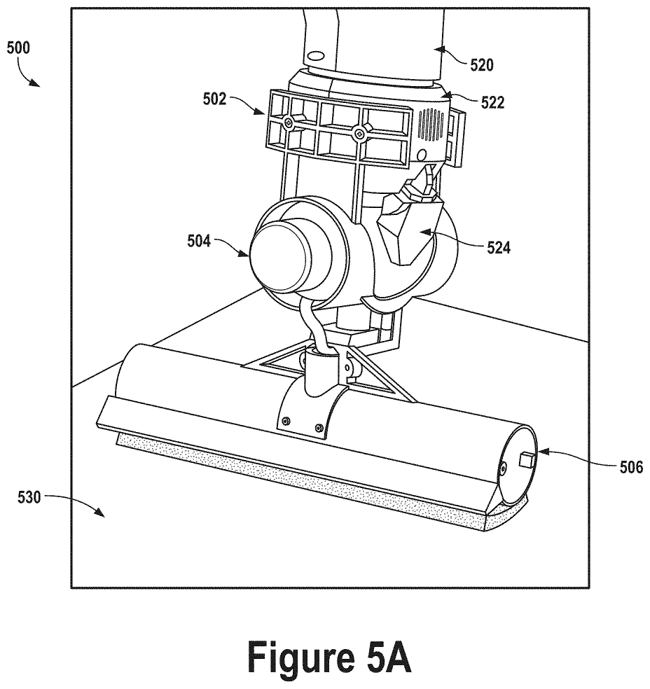

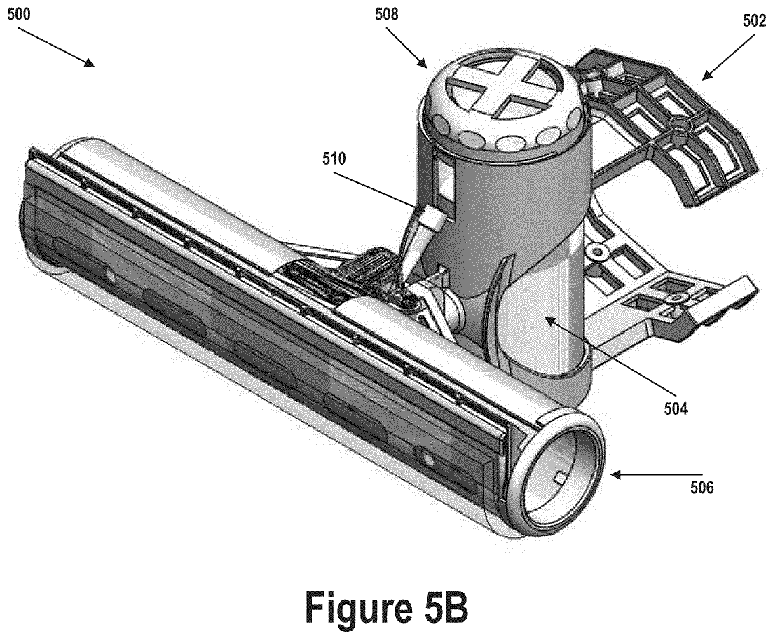

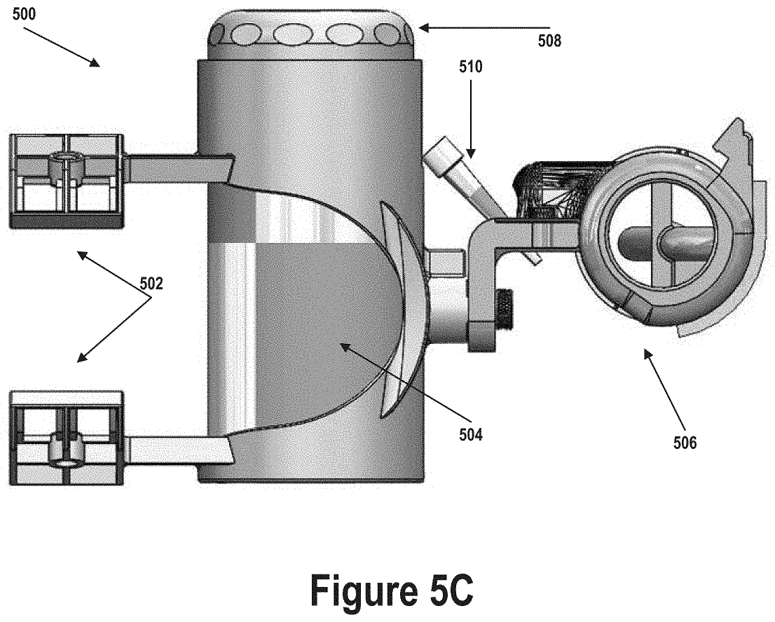

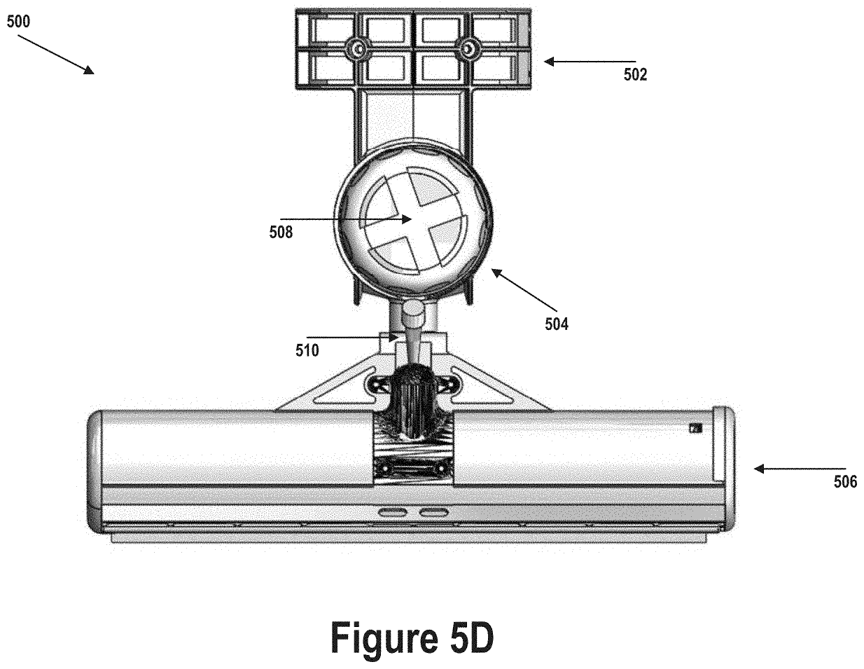

FIGS. 5A-5D show an attachable wiping tool for a robotic device, in accordance with example embodiments. More specifically, FIG. 5A illustrates an attachable wiping tool 500 attached to a robotic device 520. The attachable wiping tool 500 includes an attachment component 502 coupled to a wrist 522 of the robotic device 520. The wrist 522 may be operable to rotate the end effector of the robotic device 520. In this case, the end effector includes two opposable robotic fingers 524. The fingers 524 may be customized to interface with the attachable wiping tool 500.

In the illustrated example, the attachable component 502 is a mounting bracket which holds a fluid container 504 in position relative to the two opposable fingers 524 of the robotic device 520. Accordingly, when the robotic device 520 actuates the opposable fingers 524 to rotate inward, the fingers 524 will engage with the fluid container 504. As pressure is applied to the fluid container 504, fluid may be dispensed to the wiping component 506 of the attachable wiping tool 500. In the illustrated example, the wiping component 506 includes a tube and sponge oriented perpendicular to the fluid container 504. In some examples, the tube of the wiping component may further include one or more circular internal support stiffeners. Fluid may be applied to the back of the sponge to saturate the sponge to enable cleaning of surface 530 in environment 500.

FIGS. 5B, 5C, and 5D illustrate additional views of the attachable wiping tool 500. More specifically, FIG. 5B provides an isometric view, FIG. 5C provides a side view, and FIG. 5D provides a top down view. In each view of the attachable wiping tool 500, the attachment component 502, the fluid container 504, and the wiping component 506 are displayed. The attachable wiping component 500 additionally includes a screw on lid 508 to hold the container 504. More specifically, the container 504 may take the form of a removable bottle (e.g., a soft plastic bottle) which may be removed and refilled or replaced via the screw on lid 508. In further examples, the lid 508 may instead include a snap in connection to hold the container 504.

In order for the container 504 to dispense the fluid to the wiping component 506, the container 504 may include a tubing 510 which attaches to one or more hoses of the attachable wiping tool 500. The one or more hoses may distribute the fluid to the back of the wiping component 506 (e.g., to saturate a sponge for surface cleaning). In some examples, the attachable wiping tool 500 may include two or more such hoses. A splitter may be provided to divide fluid among each of the hoses. Each hose may then distribute the fluid to a different portion of the wiping component 506. For instance, each hose may provide fluid to a different portion of a sponge of the wiping component 506. In further examples, the wiping component 506 may include multiple sponges, and each hose may provide fluid to a different sponge of the wiping component 506.

As noted, the wiping component 506 of the attachable wiping tool 500 may generally be positioned perpendicular to the container 504. In some examples, the attachable wiping tool 500 may include one or more hardstops to maintain the wiping component within a certain threshold from a perpendicular orientation to the container. The hardstop(s) may be configured to limit rotation of the wiping component, keep the wiping component centered, and/or keep the wiping component within a bounding box. In further examples, the hardstop(s) may act as a clutch to allow slippage before the wiping component 506 completely breaks off.

In further examples, the wiping component 506 may comprise a different material and/or form factor. In some such examples, the wiping component 506 may include a stiff rubber support backing to act as a squeegee. In further examples, the wiping component 506 may include a rubber strip in combination with another material, such as a sponge.

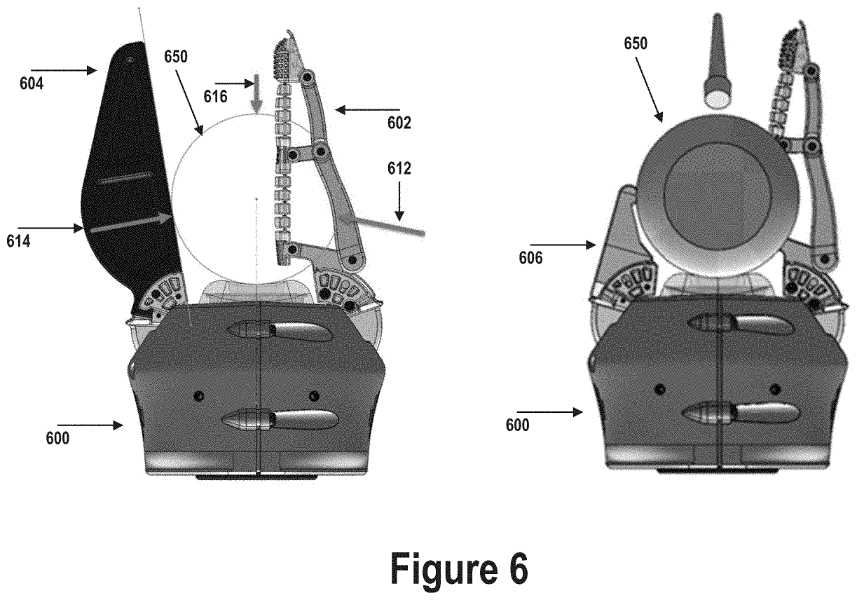

FIG. 6 illustrates robotic fingers associated with a surface wiping tool, in accordance with example embodiments. More specifically, different types of robotic fingers may be used in conjunction with a surface wiping tool. In some examples, a robotic gripper may include interchangeable digits. In such examples, a particular set of digits may be attached to the gripper specifically to interface with the fluid container of a surface wiping tool. The particular set of digits may be designed to apply an increased amount of force to the fluid container in comparison to a set of digits typically used by the robot.

In reference to FIG. 6, a robotic gripper 600 may include digits 602 and 604. In some examples, a typical digit used by the robotic device may be an underactuated digit with unactuated joints to allow for conforming to objects, such as illustrated by digit 602. When the digits are actuated with a surface wiping tool attached to the robot, pressure may be applied to a fluid container 650 from at least three directions 612, 614, and 616. More specifically, while a finite amount of force can be applied to the container 650 via gripper finger torque alone, additional reactionary normal force can be applied opposite to the fingers by securing the container 650 from moving within the surface wiping tool. The direction of the reactionary normal force is illustrated by arrow 616.

In some examples, one or more digits may be designed specifically for use with a particular container size and associated surface wiping tool. More specifically, a shorter digit 606 may be used to apply greater force to the container 650. Two digits with the form factor illustrated by digit 606 may be used to apply increased force to the container 650 in comparison to, e.g., digits of the form factor illustrated by digit 602. In some examples, a pair of digits having the form factor illustrated by digit 606 may be interchangeable digits which can be attached to the gripper 600 specifically for operating the surface wiping tool. As illustrated in FIG. 6, digits of the form factor illustrated by digit 606 may be configured to be attached to the same dovetail component of the gripper as digits of the form factor illustrated by digit 602.

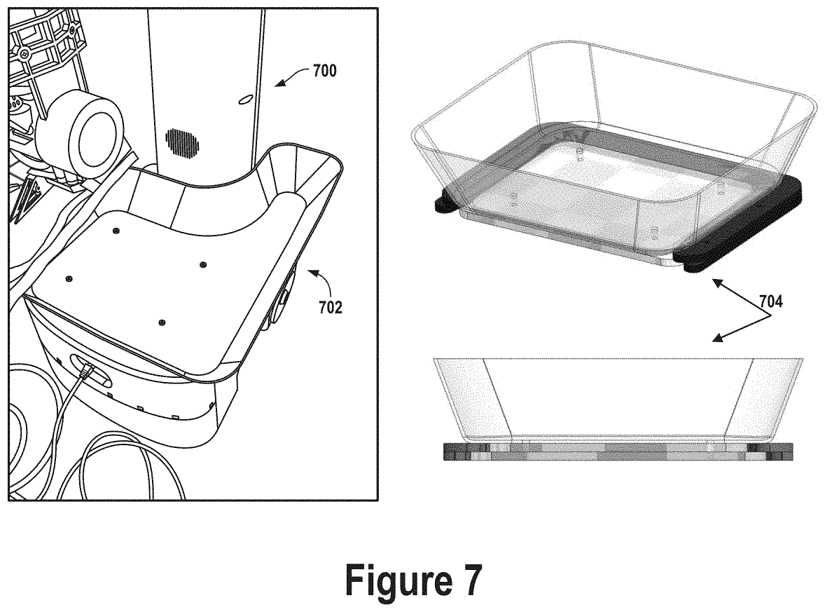

FIG. 7 illustrates a tray for a robot, in accordance with example embodiments. More specifically, a robot 700 may be equipped with a tray 702 for collecting debris, including debris that may be collected while employing a surface wiping tool as described herein. The robot 700 may be configured with a form factor that allows for positioning of the tray underneath surfaces in the environment, such as table tops. The robot 700 may then easily sweep debris from the surfaces into the tray 702. In some examples, the tray 702 may be removable to facilitate emptying of the tray 702. More specifically, the tray 702 may be connected to the base of the robot 700 via a sliding connection to allow a user to slide out the tray 702 and empty the tray 702.

In further examples, a removable tray may also take on the form factor illustrated by tray 704 as well. A captured plate mechanism may be used to slide the tray on and off without requiring any additional tools. In reference to FIG. 7, the dark colored plates of tray 704 are designed to be attached to the robot base while the light colored plates of tray 704 are designed to be attached to the tray 704 itself.

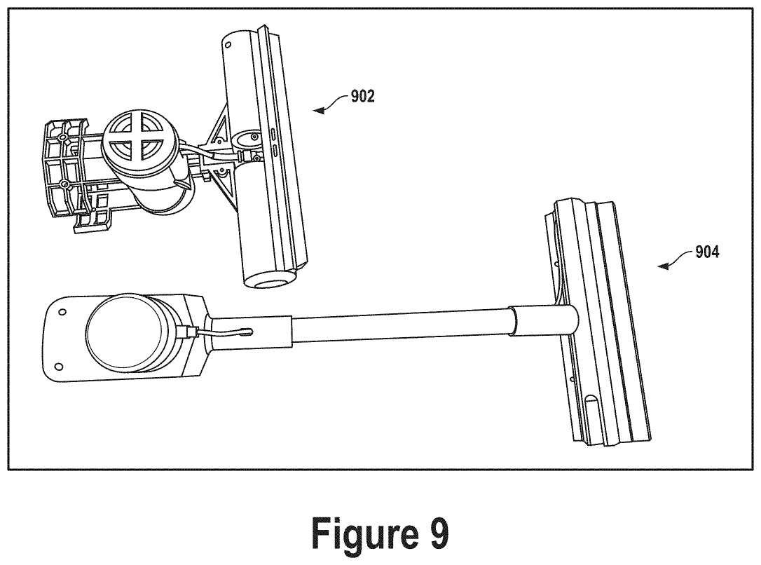

FIG. 9 illustrates another surface wiping tool, in accordance with example embodiments. More specifically, surface wiping tool 902 may be similar to the surface wiping tool described in reference to FIGS. 5A-5D. Surface wiping tool 904 illustrates an alternative form factor with increased length. Surface wiping tool 904 may operate similarly as surface wiping tool 902 in allowing fluid to reach the sponge from the fluid container through operation of robotic fingers. Surface wiping tool 904 may provide improved flexibility for a robotic device in allowing the robotic device to reach surfaces in the environment for wiping.

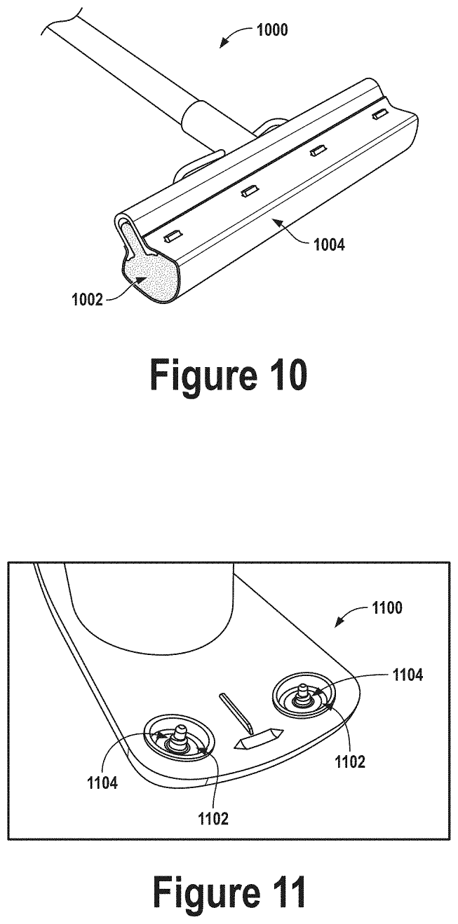

FIG. 10 illustrates a surface wiping tool with removable sponge and detachable cloth, in accordance with example embodiments. More specifically, the sponge 1002 may be an off-the-shelf sponge capable of sliding on and off of the surface wiping tool 1000. Removable sponge 1002 may generally be easy to manufacture and attach to or detach from the surface wiping tool 1000. In further examples, a less thick sponge may be used in order to absorb less fluid to avoid putting excessive torque on the robot. Cloth 1004 surrounding sponge 1002 may be attached to the sponge 1002 using the illustrated attachment mechanism or another suitable attachment mechanism. Cloth 1004 may be removable to allow for easy replacement of cloth 1004 after use by a robotic device.

FIG. 11 illustrates a captive fastener for a surface wiping tool, in accordance with example embodiments. More specifically, a surface wiping tool, such as surface wiping tool 904 from FIG. 9, may include a captive fastener 1100 using magnets 1102 and associated steel retaining rings 1104 around shoulder bolt thumb screws. The captive fastener 1100 may allow the surface wiping tool to be attached to the robot, but may also prevent fasteners from being separated from the tool. Each steel retaining ring 1104 is attracted to the corresponding magnet 1102, which creates a stable retracted position that pulls the screw out of the hole, to allow for the easy removal of the surface wiping tool from the wrist of a robotic device.

### IV. Example Methods

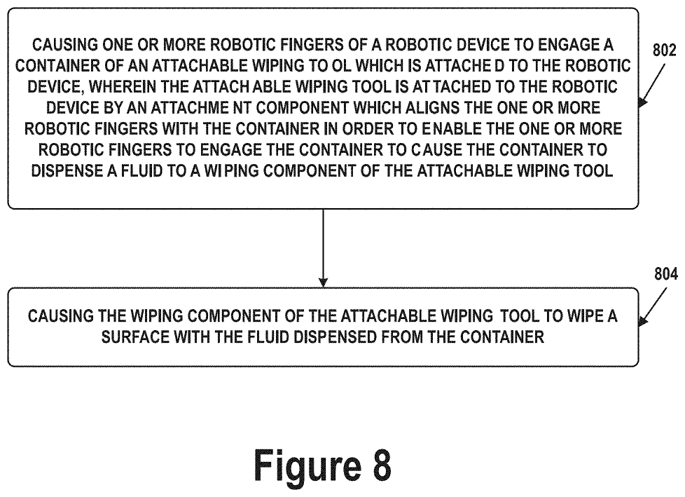

FIG. 8 is a block diagram of method 800, in accordance with example embodiments. Blocks 802 and 804 may collectively be referred to as method 800. In some examples, method 800 of FIG. 8 may be carried out by a control system, such as control system 118 of robotic system 100. In further examples, method 800 of FIG. 8 may be carried out by a computing device or a server device remote from the robotic device. In still further examples, method 800 may be carried out by one or more processors, such as processor(s) 102, executing program instructions, such as program instructions 106, stored in a data storage, such as data storage 104. Execution of method 800 may involve a robotic device, such as the robotic device illustrated and described with respect to FIGS. 1-4. Other robotic devices may also be used in the performance of method 800. Execution of method 800 may further involve an attachable wiping tool attached to a robotic device as described herein.

Those skilled in the art will understand that the block diagram of FIG. 8 illustrates functionality and operation of certain implementations of the present disclosure. In this regard, each block of the block diagram may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art.

At block 802, method 800 involves causing one or more robotic fingers of a robotic device to engage a container of an attachable wiping tool. The attachable wiping tool may be attached to the robotic device by an attachment component, for instance, a brace mounted to a wrist of the robotic device. The attachment component may align the one or more robotic fingers with the container. The attachment component may therefore enable the one or more robotic fingers to engage the container to cause the container to dispense a fluid. The fluid may be dispensed to a wiping component of the attachable wiping tool.

At block 804, method 800 involves causing the wiping component of the attachable wiping tool to wipe a surface with the fluid dispensed from the container. In some examples, the fluid may first be applied to the wiping component (e.g., a sponge), which is then moved by the robot across a surface to clean the surface. In further examples, the fluid may be applied through a cutout portion of the wiping component so that the fluid is directly applied to a surface in the environment of the robot. The robot may then control the wiping component to move the wiping component across the surface in order to wipe the surface with the fluid.

Method 800 or other methods contemplated herein may additionally involve further control steps as well or instead. Such additional functions may be performed while cleaning surfaces of an environment with a robot. Further additional functions may be performed while performing one or more other services with a robot in the environment as well or instead.

A. Using Machine Learning to Identify a Broken Tool

In some examples, an attachable wiping tool may periodically be bumped askew, for instance, due to imprecise control of the robot in determining where to wipe. In such examples, an intervention may be added (e.g., in the form of a human operator) to determine a state of the tool (e.g., a misaligned tool, a broken tool, etc.) and correct any issues. Data from such interventions may be used to train a machine learning model such as a neural network to use image data to identify such issues with the tool. In some examples, a pretrained network from publicly available image caption data may be used as a baseline model. The baseline model may then be fine tuned using data from operations, such as interventions. After training, when the trained model indicates that a tool is askew or damaged, a robot may be configured to pause operation and raise an alert to an operator to come and fix the tool. This methodology may be applied to other types of tools as well or instead.

B. Using Queues to Parallelize for Speed

In some examples, robotic cleaning operations may be improved and made faster by using two or more independent control systems that feed into each other with queues. As an example, three independent systems may be used to control robotic operation: a head and graphics processing unit (GPU) for perception, a central processing unit (CPU) for motion planning, and an arm that can execute manipulation plans. The head and perception module may be configured to find a next section of a table or other surface and add the section to a “to wipe” list. The CPU may perform arm motion planning to find collision-free paths to wipe. The arm and base may execute these wiping plans to wipe the table or other surface. In further examples, different combinations of two or more control systems may be used with different divisions of sub-tasks. Additionally, this methodology of using independent control systems with queues may be applied to other types of robot manipulation tasks as well or instead.

C. Automatic Coverage Metric

In some examples, a robot may be configured to automatically measure its performance in performing a task such as a cleaning task and provide data about the task that the robot is performing. This data may be data from table detection perception. This process may involve full building localization to understand which parts of a surface have already been wiped if the robot comes around to wipe from the other side. The robot may understand where its wiping tool is positioned in order to obtain an understanding of which parts of surfaces have been contacted. Additionally, the robot may be configured to sense forces so that the robot can tell the difference between almost touching a surface or grazing the surface in comparison to fully wiping the surface. Performance data may be used to adjust robot behavior in real time and/or train one or more models to improve future performance. Similar methodology may be applied to other types of robot tasks besides cleaning tasks as well or instead.

D. Scenario Testing For Continuous Improvement

In some examples, examples of challenging environments (e.g., challenging types of tables for a cleaning task) may be harvested from robot logs. Updated versions of software to control robot operations (e.g., surface wiping operations) may be run on logged robot data to determine if one or more metrics of robot performance (e.g., success rate and wiping coverage) improve over time. Tools may be developed to turn a failed test into a scenario for training. Automated tests may be run on new software code to identify regressions in robot performance. This methodology may also provide information about improvements so that requirement thresholds can be increased over time as robot performance improves. This methodology may be applied to other types of robot tasks besides cleaning or surface wiping tasks as well or instead.

E. Multi-Robot Coordination

In some examples, performance of some robot tasks may depend on performance of other types of robot tasks. For example, a robot may be better able to wipe tables when the chairs around the table are pushed in all the way, but it may be easier for a robot to push in chairs if the robot is not currently equipped with an attachable wiping tool. In such a case, one robot may be controlled to navigate around the environment and note where chairs are pushed all the way in and otherwise pushing the chairs in. Tables with chairs that are fully pushed in may then be added to a work queue by the robot. One or more other robots designated as wiping robots with attached wiping tools may then be controlled to select tables in the queue and claim tables to clean. This methodology may be applied to other types of robot tasks (besides cleaning or wiping tasks) that depend upon the performance of other types of robot tasks as well or instead.

### V. Conclusion

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software or hardware modules in the same physical device. However, other information transmissions may be between software modules or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A robotic device, comprising:
one or more robotic fingers; and
an attachable wiping tool, comprising:
a wiping component;
a container configured to dispense a fluid; and
an attachment component coupled to the robotic device, wherein the attachment component is configured to align the one or more robotic fingers with the container such that the one or more robotic fingers, when actuated, engage the container to cause the container to dispense the fluid to the wiping component.

2. The robotic device of claim 1, wherein the wiping component comprises a sponge.

3. The robotic device of claim 1, wherein the attachable wiping tool comprises at least one hose, wherein the container comprises a tubing configured to connect to the at least one hose to enable the container to dispense the fluid to the wiping component.

4. The robotic device of claim 3, wherein the attachable wiping tool further comprises a splitter, wherein the at least one hose comprises at least two hoses, and wherein the splitter is configured to split the fluid dispensed by the container between the at least two hoses.

5. The robotic device of claim 1, wherein the attachment component is configured to attach to a wrist of the robotic device, wherein the wrist is configured to rotate the one or more robotic fingers.

6. The robotic device of claim 1, comprising at least two sets of detachable fingers, wherein the one or more fingers comprises a first set of detachable fingers, wherein the first set of detachable fingers is configured to exert a higher force on the container than a second set of detachable fingers of the at least two sets of detachable fingers.

7. The robotic device of claim 1, wherein the wiping component comprises a cutout portion such that the fluid is dispensed from the container directly onto a surface to be wiped by the wiping component.

8. The robotic device of claim 1, further comprising a base and a tray positioned on the base such that the tray is positionable to enable wiping of debris by the wiping component into the tray.

9. The robotic device of claim 8, wherein the tray is removable via a sliding connection to enable emptying of the tray.

10. The robotic device of claim 1, wherein the wiping component comprises a stiff rubber support backing.

11. The robotic device of claim 1, wherein the wiping component comprises a tube with one or more circular internal support stiffeners.

12. The robotic device of claim 1, wherein the container comprises a removable bottle, wherein the robotic device further comprises a screw on lid configured to contain the removable bottle.

13. The robotic device of claim 1, wherein the attachable wiping tool comprises one or more hardstops configured to maintain the wiping component within a certain threshold from a perpendicular orientation to the container.

14. An attachable wiping tool for a robotic device, the attachable wiping tool comprising:
a wiping component;
a container configured to dispense a fluid; and
an attachment component configured to couple to the robotic device, wherein the attachment component is configured to align one or more robotic fingers of the robotic device with the container such that the one or more robotic fingers, when actuated, engage the container to cause the container to dispense the fluid to the wiping component.

15. The attachable wiping tool of claim 14, wherein the wiping component comprises one or more sponges.

16. The attachable wiping tool of claim 14, wherein the container comprises a removable bottle.

17. The attachable wiping tool of claim 16, wherein the attachable wiping tool comprises at least one hose, wherein the removable bottle comprises a tubing configured to connect to the at least one hose to enable the container to dispense the fluid to the wiping component.

18. The attachable wiping tool of claim 17, further comprising a splitter, wherein the at least one hose comprises at least two hoses, and wherein the splitter is configured to split the fluid dispensed by the container between the at least two hoses.

19. The attachable wiping tool of claim 14, further comprising one or more hardstops configured to maintain the wiping component within a certain threshold from a perpendicular orientation to the container.

20. A method, comprising:
causing one or more robotic fingers of a robotic device to engage a container of an attachable wiping tool which is attached to the robotic device, wherein the attachable wiping tool is attached to the robotic device by an attachment component which aligns the one or more robotic fingers with the container in order to enable the one or more robotic fingers to engage the container to cause the container to dispense a fluid to a wiping component of the attachable wiping tool; and
causing the wiping component of the attachable wiping tool to wipe a surface with the fluid dispensed from the container.
